(19) United States
(12) Patent Application Publication
(10) Pub. No.: US 2023/0146438 A1
(43) Pub. Date: May 11, 2023

(54) LED POWER SUPPLY AND LED LAMP

(71) Applicant: Changzhou Jutai Electronic Co., Ltd., Changzhou (CN)

(72) Inventors: Wei Huang, Changzhou (CN); Chengqian Pan, Changzhou (CN); Bin Chen, Changzhou (CN)

(21) Appl. No.: 17/532,092

(22) Filed: Nov. 22, 2021

(30) Foreign Application Priority Data
Nov. 8, 2021 (CN) 2021227116717

(51) Int. Cl. H05B 45/3725; F21V 31/00; F21V 23/00

(52) U.S. Cl. CPC H05B 45/3725; F21V 31/005; F21V 23/008; F21Y 2115/10

(57) ABSTRACT

The present utility discloses An LED power supply, comprising a housing, a light-emitting mode switching component a circuit board, an output socket, and an input conductive plug, wherein the housing comprises a main housing and an end cover, the main housing is integrally formed, an accommodating cavity is provided inside the main housing, one end of the main housing is closed and the other end thereof is provided with an opening, the input conductive plug and one end of the main housing are cast integrally, one end of the input conductive plug is located in the accommodating cavity, the side wall of the main housing is provided with a through hole, a part of the light-emitting mode switching component forms a sealing fit with the through hole and is fixed with the main housing, at least a part of the circuit board is located in the accommodating cavity and is electrically connected with the input conductive plug, one end of the light-emitting mode switching component is matched or fixed with the circuit board, after the end cover is fixed with the opening of the main housing, the end cover forms a sealed combination with the main housing, the output socket is provided on the end cover, the axial direction of the output socket is parallel to the input conductive plug, or the included angle formed by the axial direction of the output socket and the input conductive plug is less than 3 degrees. The present utility model provides with improved waterproof reliability.

### TECHNICAL FIELD

The present utility model relates to an LED power supply and an LED lamp.

### BACKGROUND

As shown in FIGS. 6d and 6e, the structure of the existing LED power supply comprises a housing, a light-emitting mode switching component 3, a circuit board 4 and an output socket 5. The axial direction of the input conductive plug 6 of this converter plug is perpendicular to the axial direction of the output socket 5, so that it is also referred to as a horizontal converter plug.

The above housing consists of an upper cover 1 and a lower cover 2. The upper cover 1 is provided with a mounting hole. During assembly, the light-emitting mode switching component 3 is assembled in the mounting hole. The circuit board 4 is matched with the lower cover 2. The output socket 5 is mounted in the groove at the tail of the upper cover 1. After the upper cover 1 and the lower cover 2 are combined, the upper cover 1 and the lower cover 2 are welded by ultrasonic waves. The output socket 5 is welded with the upper cover 1 and the lower cover 5 by ultrasonic waves to form a seal. The working mode of this power supply is that since the circuit board 4 is provided with a conductive area, the end face of the conductive key 3 is provided with conductive films. The light-emitting mode switching component 3 is pressed so that the conductive film on the light-emitting mode switching component 3 is in contact with the conductive area on the circuit board, so as to generate pulse signals to the circuit board. After each press, a pulse signal is generated. After receiving the pulse signals, the processor on the circuit board 4 can output corresponding control signals to control the load, so that the load can emit lights with different effects.

When the above converter plug is assembled with the circuit board 4, the circuit board 4 is closely attached to the light-emitting mode switching component 3, and the light-emitting mode switching component 3 exerts an acting force on the circuit board 4 so that the circuit board 4 deforms to a certain extent. In turn, the circuit board 4 exerts a supporting acting force on the conductive key 3, so that the light-emitting mode switching component 3 is displaced to the outside of the upper cover 1 along the axial direction of the mounting hole, and the outer circumference of the conductive key 3 fills the gap between the conductive key and the mounting hole, thus playing a waterproof role.

For the LED power supply with the above structure, when welding by ultrasonic waves, welding needs to be performed along the circumferential direction of the upper cover 1 and the lower cover 2 for a circle. The area of welding by ultrasonic waves is large. However, due to the large volume of the upper cover 1 and the lower cover 2, incomplete welding may occur in the process of welding by ultrasonic waves, and the parts that are not welded may have poor sealing performance, thus leading to water inflow when used outdoors. Therefore, for the LED power supply with the above structure, the larger the welding area, the easier it is for incomplete welding to occur.

### SUMMARY

The present utility model provides an LED power supply and an LED lamp with improved waterproof reliability.

An LED power supply, comprising a housing, a light-emitting mode switching component a circuit board, an output socket, and an input conductive plug, wherein the housing comprises a main housing and an end cover, the main housing is integrally formed, an accommodating cavity is provided inside the main housing, one end of the main housing is closed and the other end thereof is provided with an opening, the input conductive plug and one end of the main housing are cast integrally, one end of the input conductive plug is located in the accommodating cavity, the side wall of the main housing is provided with a through hole, a part of the light-emitting mode switching component forms a sealing fit with the through hole and is fixed with the main housing, at least a part of the circuit board is located in the accommodating cavity and is electrically connected with the input conductive plug, one end of the light-emitting mode switching component is matched or fixed with the circuit board, after the end cover is fixed with the opening of the main housing, the end cover forms a sealed combination with the main housing, the output socket is provided on the end cover, the axial direction of the output socket is parallel to the input conductive plug, or the included angle formed by the axial direction of the output socket and the input conductive plug is less than 3 degrees.

On the one hand, the end cover and the main housing use a sealing structure, the output socket is provided on the end cover, and the axial direction of the output socket is parallel to the axial direction of the input conductive plug, or the included angle formed by the axial direction of the output socket and the axial direction of the input conductive plug is less than 3 degrees. On the other hand, the area of the end cover and the main housing welded by ultrasonic waves is far less than the welding area of the upper cover and the lower cover in the prior art, so that the end cover and the main housing is waterproof and much more reliable than the upper cover and the lower cover combined in the prior art.

### BRIEF DESCRIPTION OF THE DRAWINGS

FIG. 1 is a cross-sectional view of a first LED power supply.

FIG. 2 is a perspective view of a first LED power supply.

FIG. 3 is a perspective view of a first main housing.

FIG. 4 is a cross-sectional view of a first main housing.

FIG. 5 is a cross-sectional view of a first light-emitting mode switching module.

FIG. 6 is a perspective view of a first end cover.

FIG. 6a is a perspective view of another end cover.

FIG. 6b is a perspective view of a second LED power supply.

FIG. 6c is a cross-sectional view of a second LED power supply.

FIG. 6d is a cross-sectional view of the existing LED power supply.

FIG. 6e is a perspective view of the existing LED power supply.

FIGS. 7a-7g are regular hexahedral projection and perspective views of a first LED power supply.

FIGS. 8a-8g are regular hexahedral projection and perspective views of a second LED power supply.

FIGS. 9a-9g are regular hexahedral projection and perspective views of a third LED power supply.

FIGS. 10a-10g are regular hexahedral projection and perspective views of a fourth LED power supply.

FIGS. 11a-11g are regular hexahedral projection and perspective views of a fifth LED power supply.

FIGS. 12a-12g are regular hexahedral projection and perspective views of a sixth LED power supply.

FIGS. 13a-13g are regular hexahedral projection and perspective views of a seventh LED power supply.

FIGS. 14a-14g are regular hexahedral projection and perspective views of an eighth LED power supply.

FIGS. 15a-15g are regular hexahedral projection and perspective views of a ninth LED power supply.

FIGS. 16a-16g are regular hexahedral projection and perspective views of a tenth LED power supply.

FIGS. 17a-17g are regular hexahedral projection and perspective views of a eleventh LED power supply.

FIGS. 18a-18g are regular hexahedral projection and perspective views of a twelfth LED power supply.

FIGS. 19a-19g are regular hexahedral projection and perspective views of a thirteenth LED power supply.

FIGS. 20a-20g are regular hexahedral projection and perspective views of a fourteenth LED power supply.

FIGS. 21a-21g are regular hexahedral projection and perspective views of a fifteenth LED power supply.

FIGS. 22a-22g are regular hexahedral projection and perspective views of a sixteenth LED power supply.

FIGS. 23a-23g are regular hexahedral projection and perspective views of a seventeenth LED power supply.

FIGS. 24a-24g are regular hexahedral projection and perspective views of a eighteenth LED power supply.

FIGS. 25a-25g are regular hexahedral projection and perspective views of a 19th LED power supply.

FIGS. 26a-26g are regular hexahedral projection and perspective views of a 20th LED power supply.

FIGS. 27a-27g are regular hexahedral projection and perspective views of a 21st LED power supply.

FIGS. 28a-28g are regular hexahedral projection and perspective views of a 22nd LED power supply.

FIGS. 29a-29g are regular hexahedral projection and perspective views of a 23rd LED power supply.

FIGS. 30a-30g are the regular hexahedral projection and perspective views of the 24th LED power supply.

FIGS. 31a-31g are regular hexahedral projection and perspective views of a 25th LED power supply.

FIGS. 32a-32g are regular hexahedral projection and perspective views of a 26th LED power supply.

FIGS. 33a-33g are regular hexahedral projection and perspective views of a 27th LED power supply.

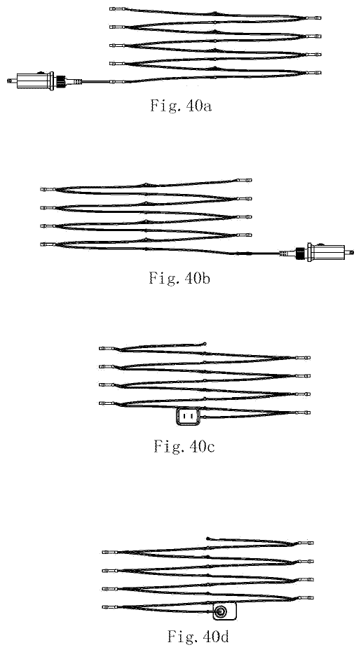

FIGS. 34a-34g are regular hexahedral projection and perspective views of a 28th LED power supply.

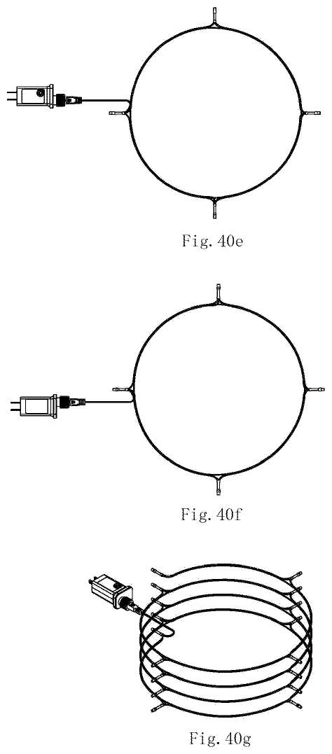

FIGS. 35a-35g are regular hexahedral projection and perspective views of a 29th LED power supply.

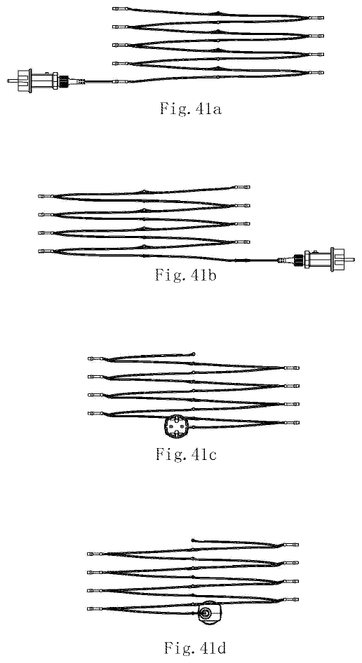

FIGS. 36a-36g are regular hexahedral projection and perspective views of a 30th LED power supply.

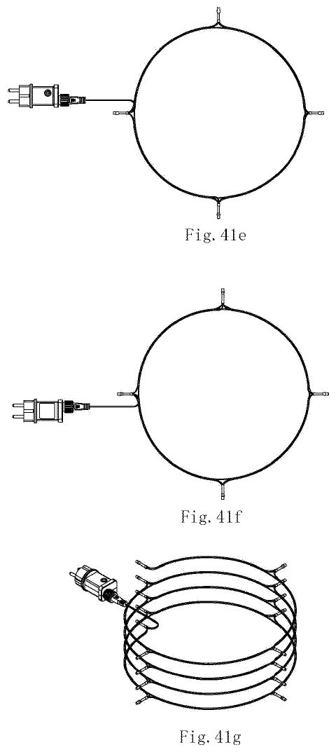

FIGS. 37a-37g are regular hexahedral projection and perspective views of a 31st LED power supply.

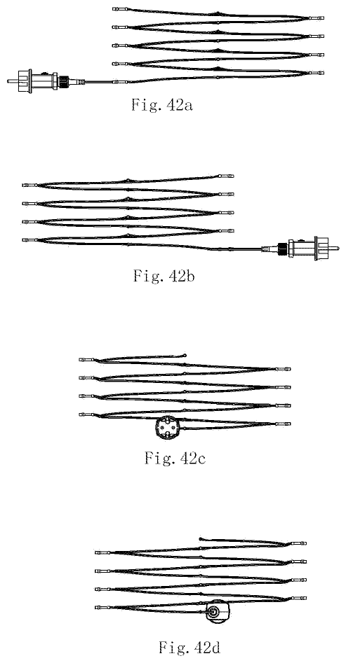

FIGS. 38a-38g are regular hexahedral projection and perspective views of a 32nd LED power supply.

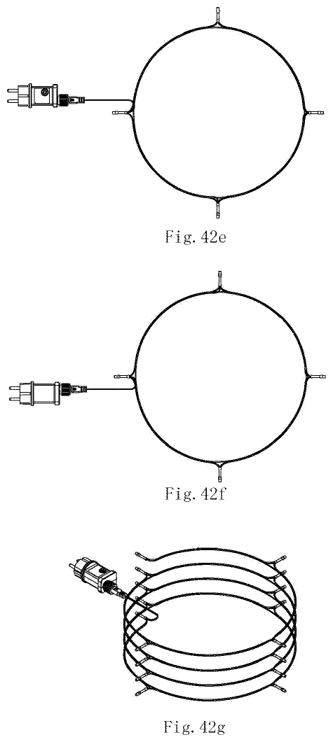

FIGS. 39a-39g are regular hexahedral projection and perspective views of a first LED lamp.

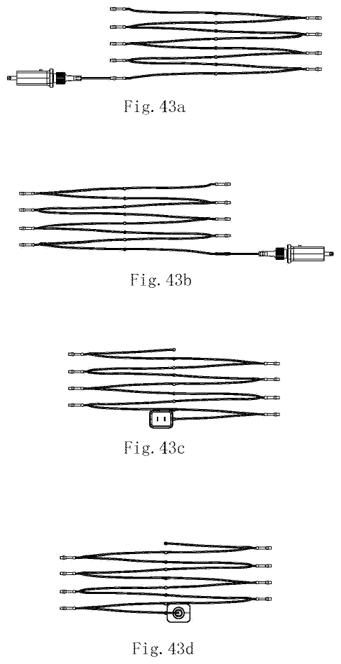

FIGS. 40a-40g are regular hexahedral projection and perspective views of a second LED lamp.

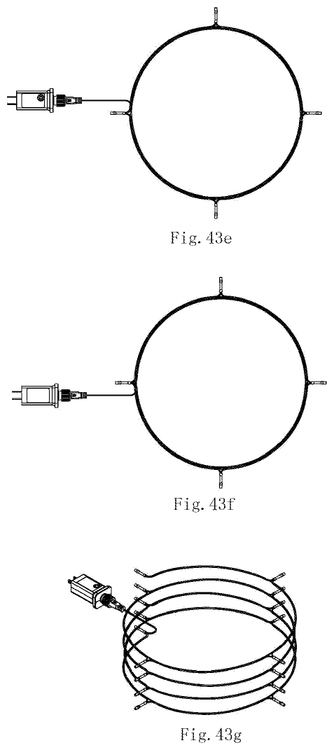

FIGS. 41a-41g are regular hexahedral projection and perspective views of a third LED lamp.

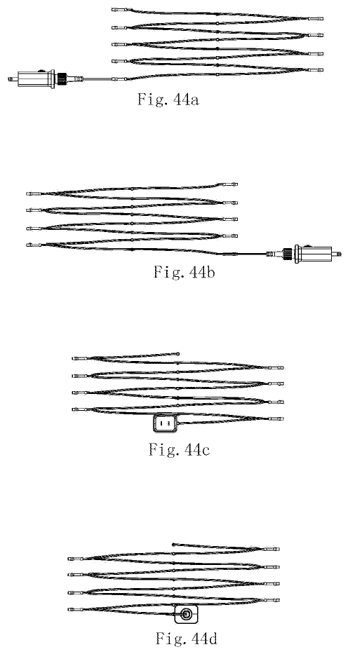

FIGS. 42a-42g are regular hexahedral projection and perspective views of a fourth LED lamp.

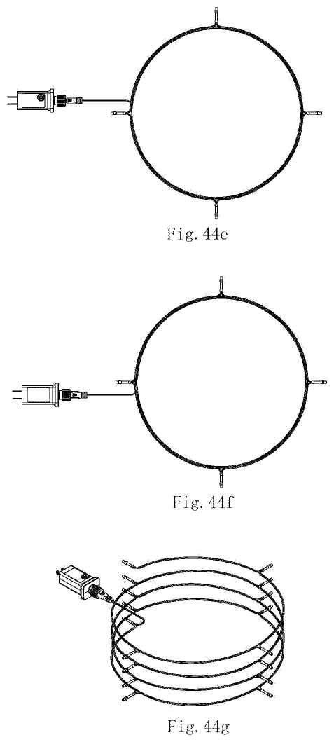

FIGS. 43a-43g are regular hexahedral projection and perspective views of a fifth LED lamp.

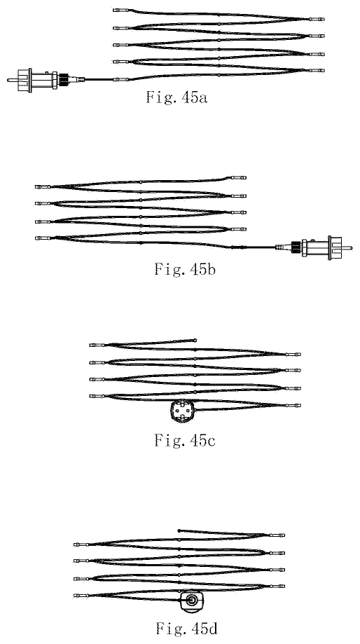

FIGS. 44a-44g are regular hexahedral projection and perspective views of a sixth LED lamp.

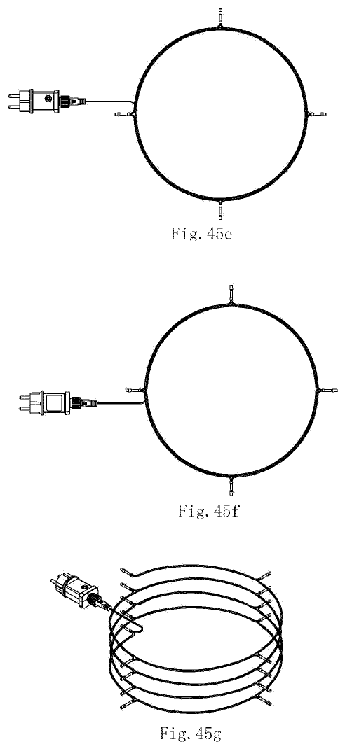

FIGS. 45a-45g are regular hexahedral projection and perspective views of a seventh LED lamp.

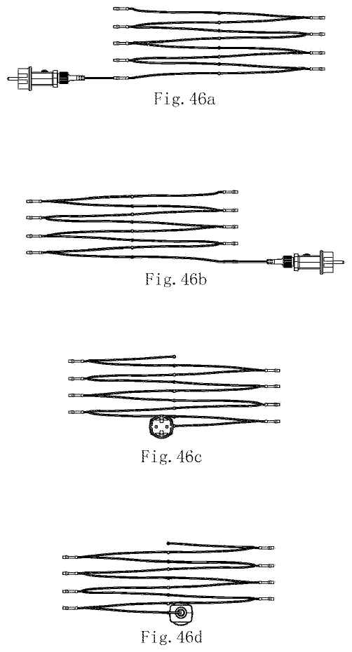

FIGS. 46a-46g are regular hexahedral projection and perspective views of an eighth LED lamp.

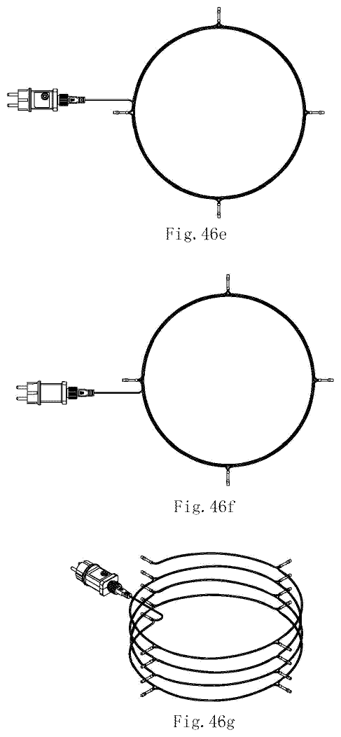

### REFERENCE NUMERALS IN THE FIGURES

An upper cover 1, a lower cover 2, a light-emitting mode switching component 3, a pressing component 3a, a sleeve 3b, a waterproof cover 3c, an annular groove 3d, a radial protrusion 3f, an elastic connection part 3g, a signal trigger component 3h, a circuit board 4, an output socket 5, an input conductive plug 6, a main housing 7, a guide groove 7a, a first inner wall surface 7b, a second inner wall surface 7c, a first distance H1, a second distance H2, an end cover 8, a limiting part 8a, an accommodating cavity 9, a through hole 10, a first hole 10a, a second hole 10b, a step 10c, a protrusion 11, a first annular groove 12, a sleeving part 13, a first annular rib 13a, a second annular rib 13b, a second annular groove 13c, a first tapered rib 13d, a nesting part 14, a third annular rib 14a, a fourth annular rib 14b, a second tapered rib 14d, an LED lamp string 15.

### DETAILED DESCRIPTION OF THE EMBODIMENTS

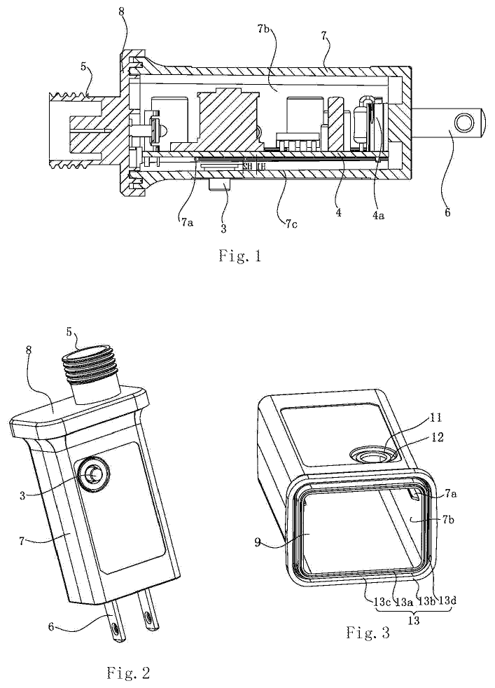

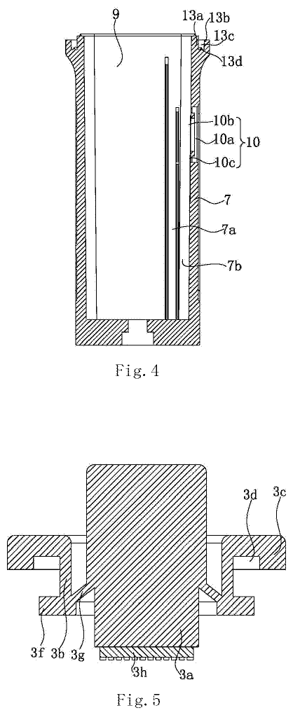

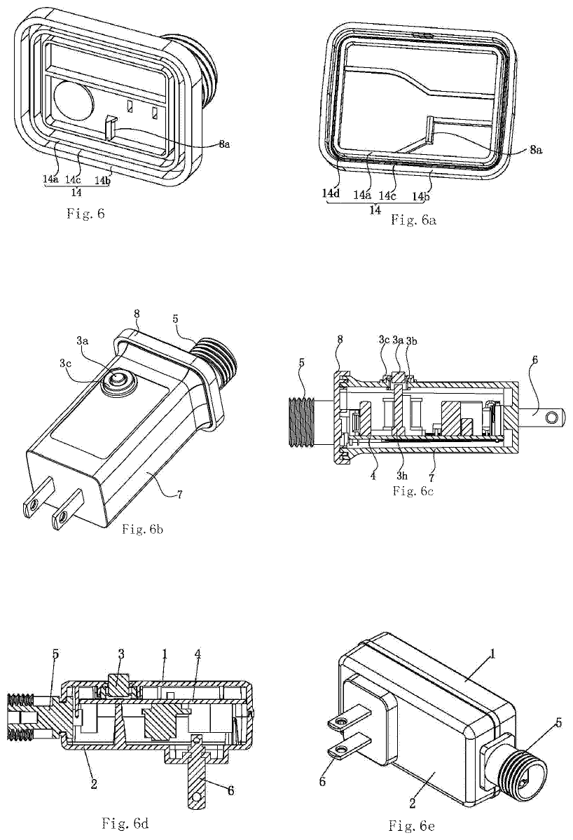

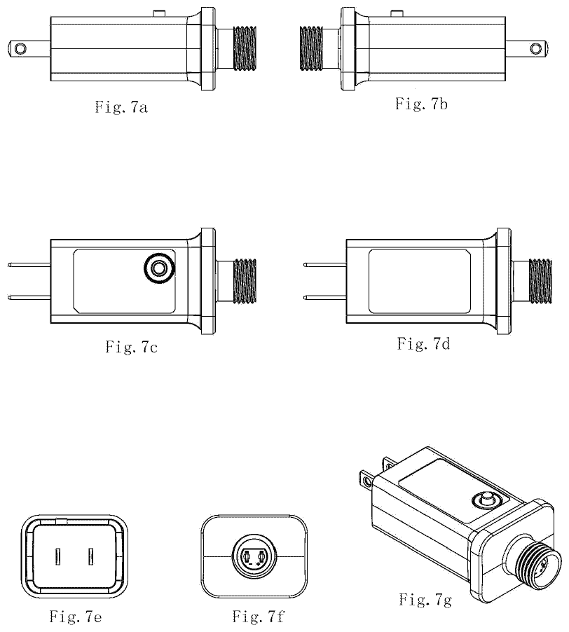

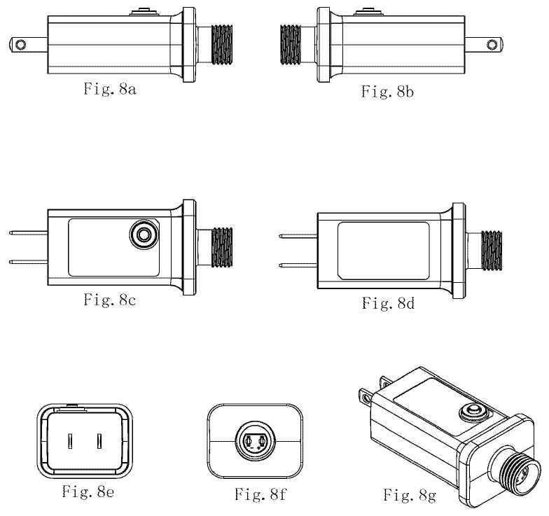

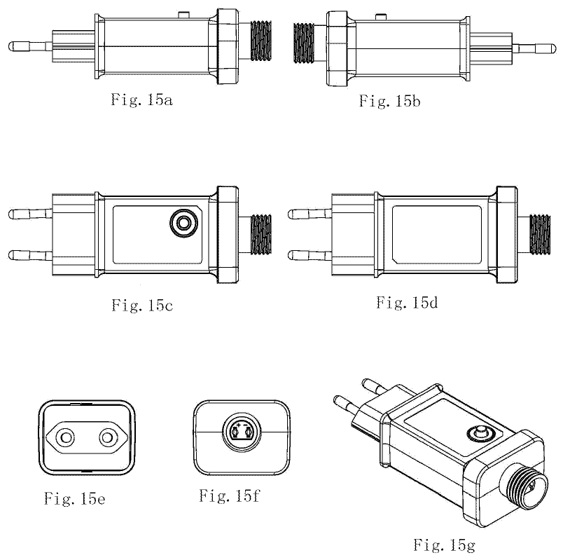

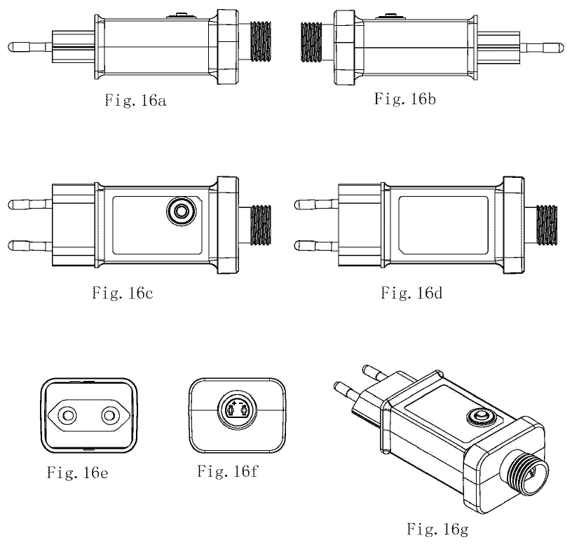

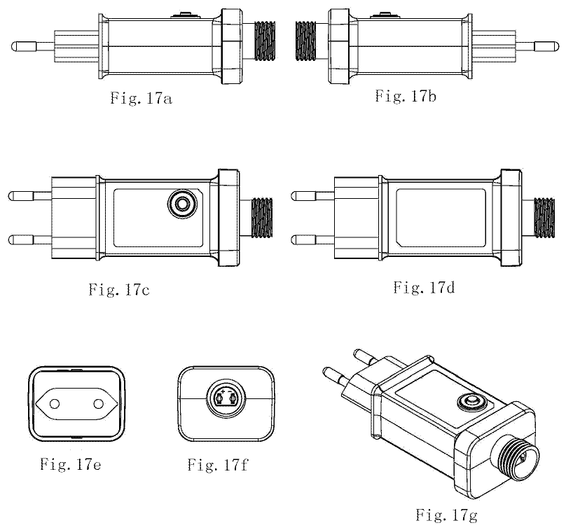

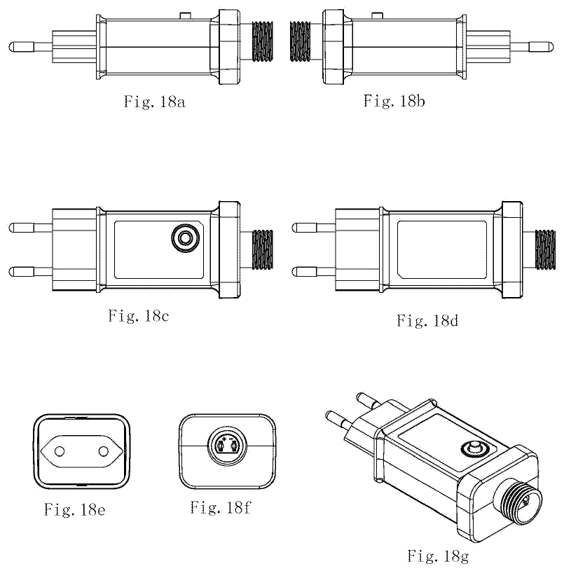

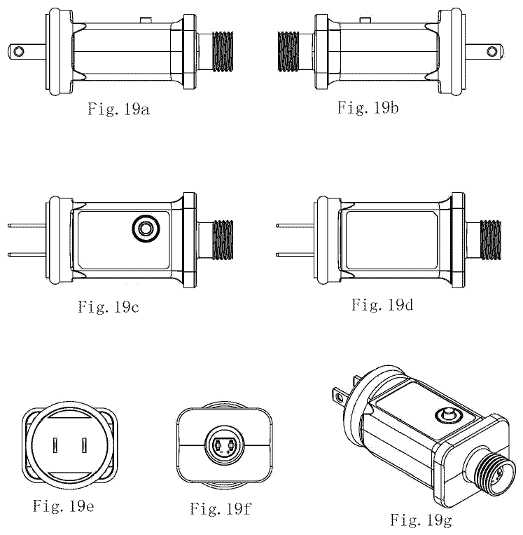

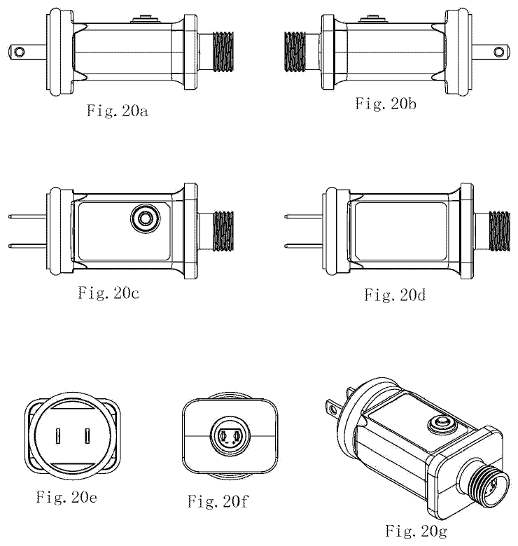

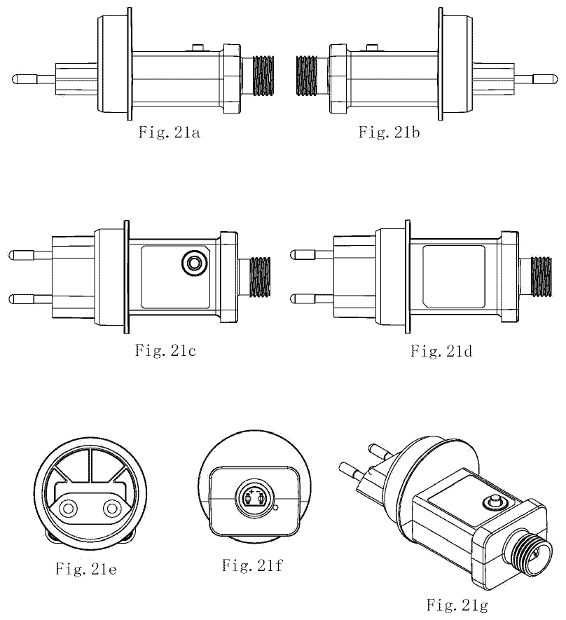

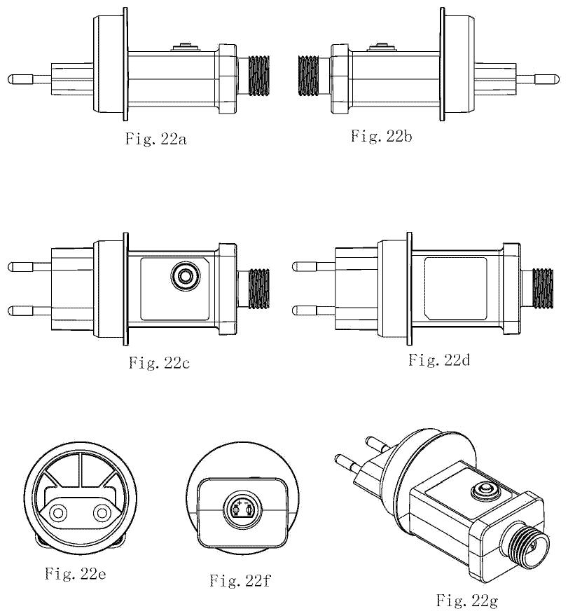

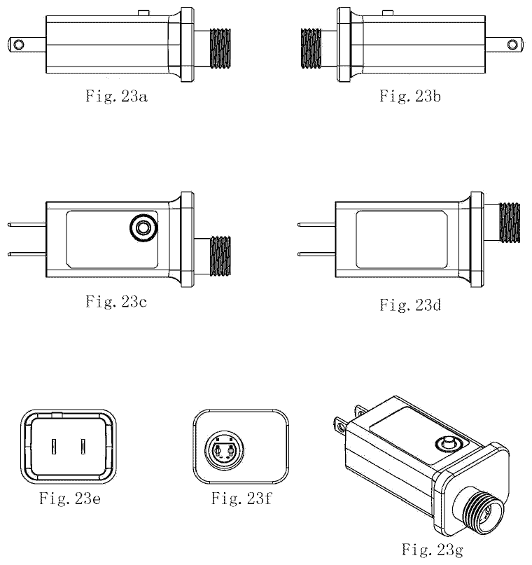

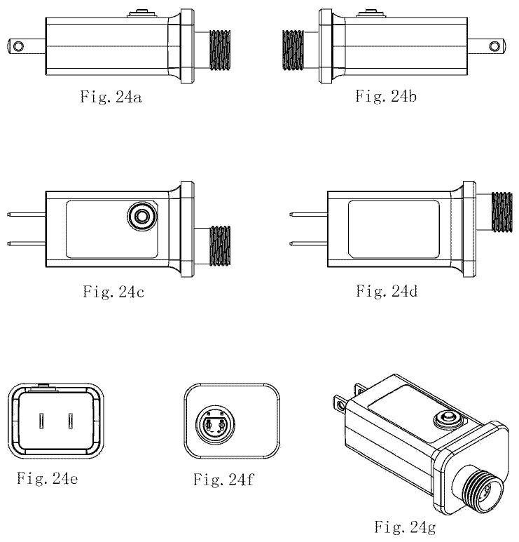

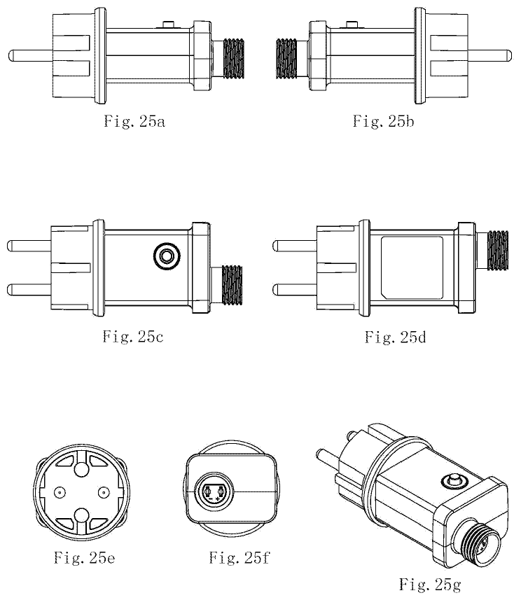

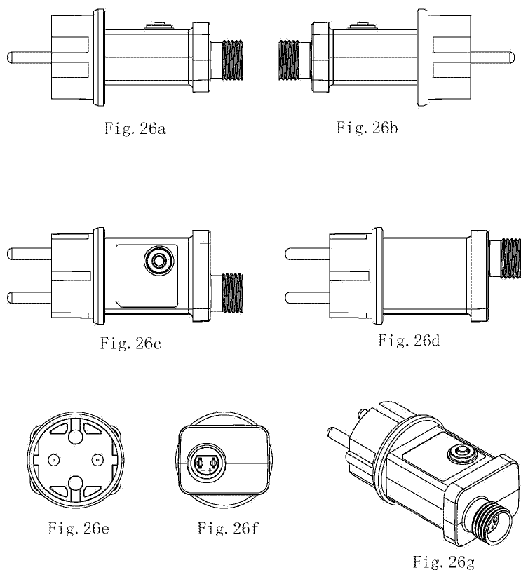

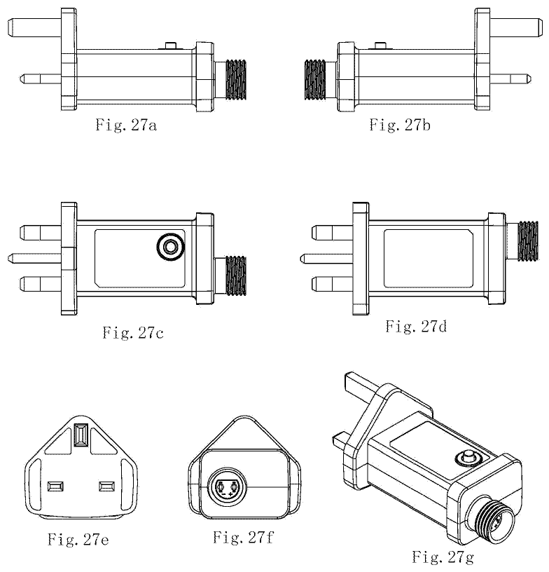

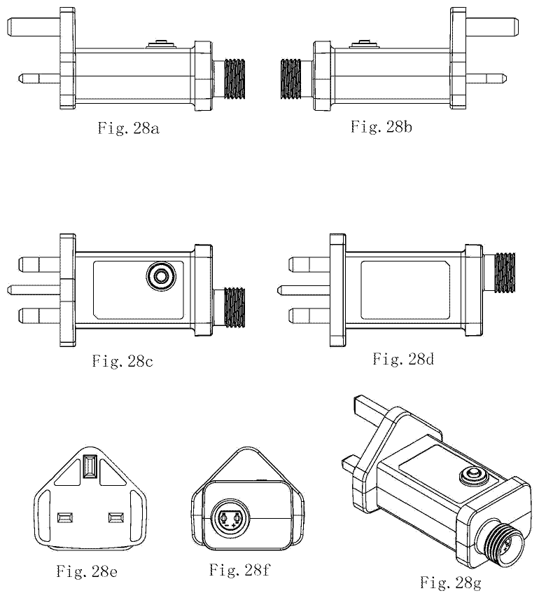

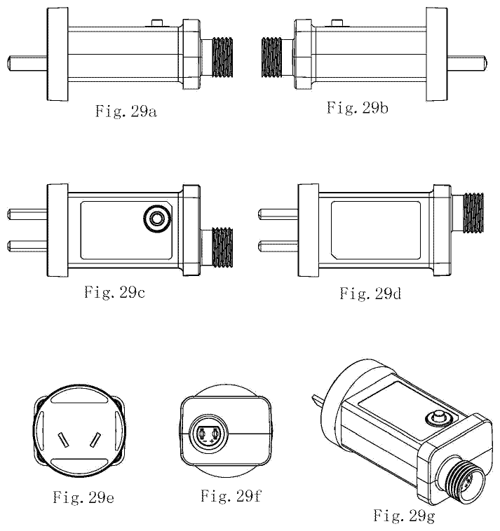

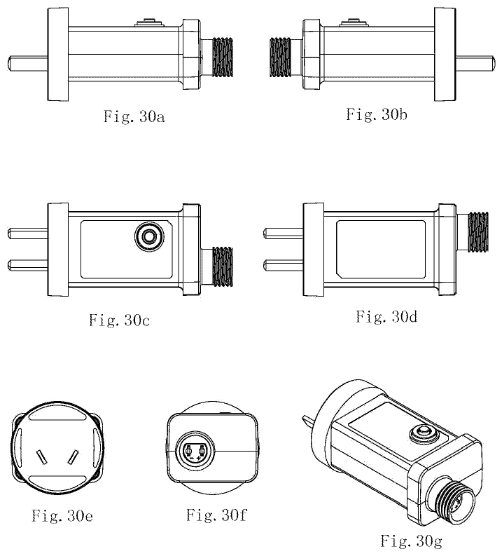

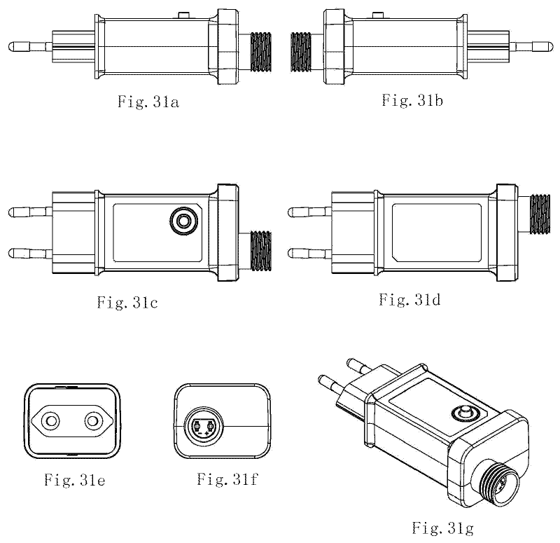

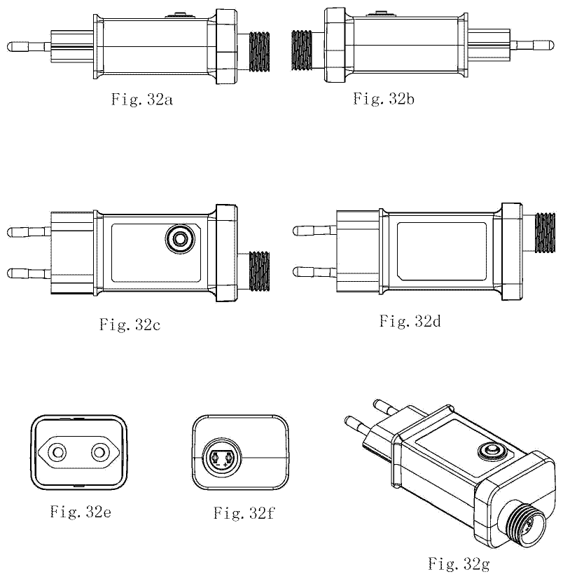

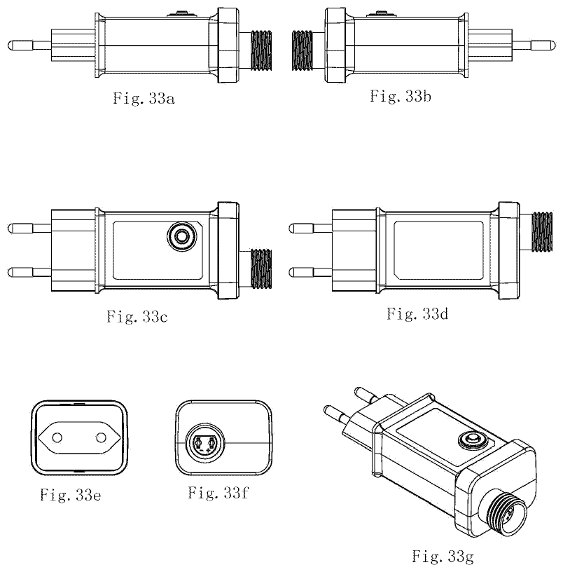

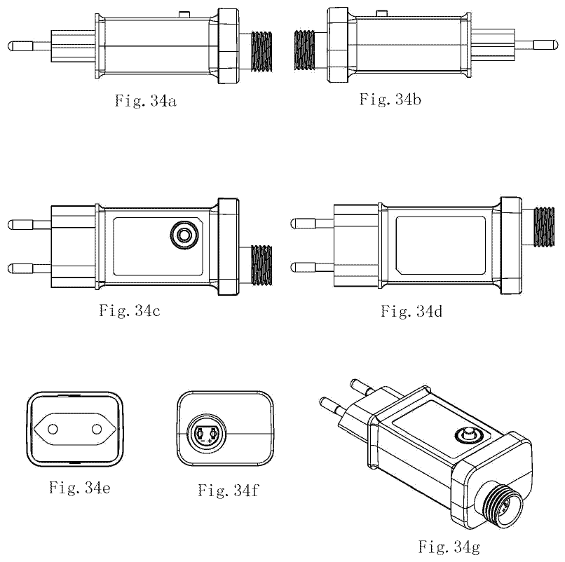

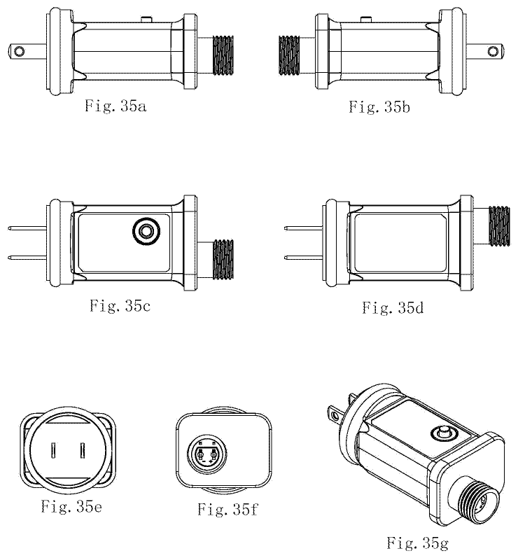

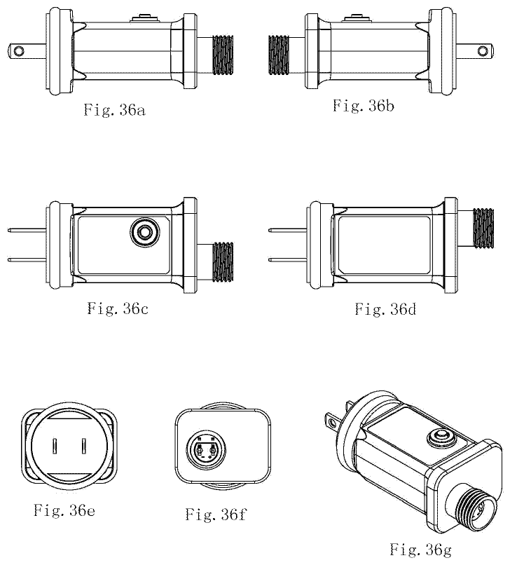

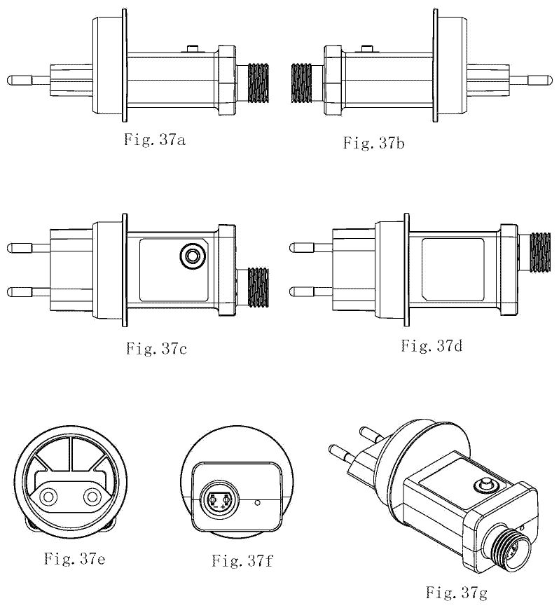

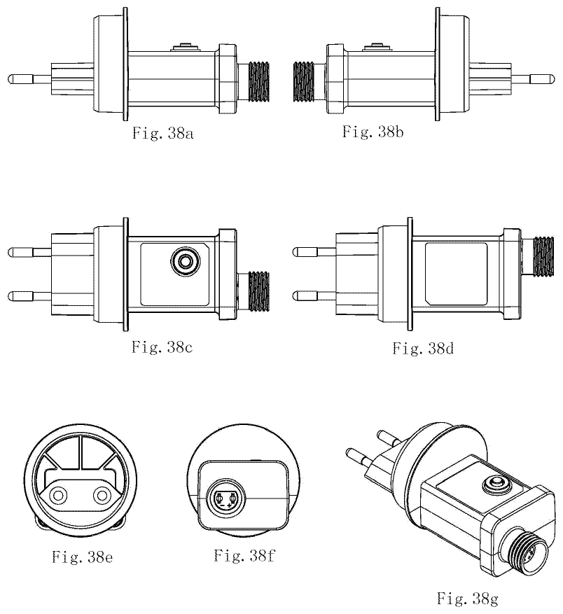

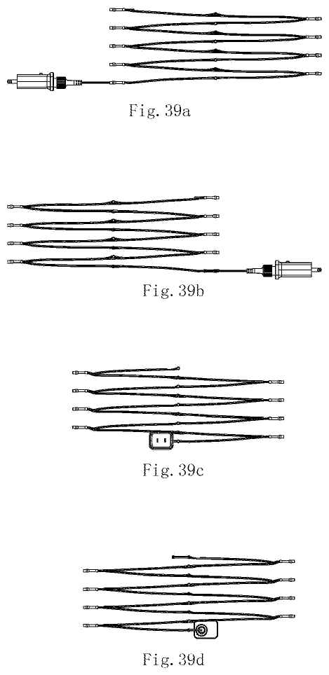

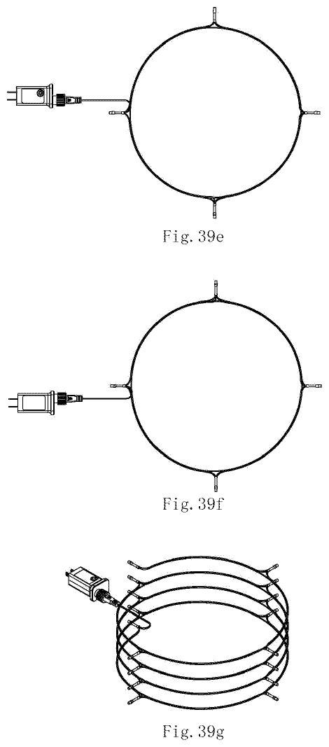

As shown in FIG. 1 to FIG. 32g, the LED power supply of the present utility model comprises a housing, a light-emitting mode switching component 3, a circuit board 4, an output socket 5, and an input conductive plug 6. Each part and their relationship will be described in detail hereinafter.

The housing comprises a main housing 7 and an end cover 8. The main housing 7 is integrally formed. The main housing 7 is made of PC or PPO material and is injection molded. An accommodating cavity 9 is provided inside the main housing 7. One end of the main housing 7 is closed and the other end thereof is provided with an opening. In this embodiment, the closed end and the open end of the main housing 7 are two opposite ends, so that the closed end and the open end are on the same axis.

The input conductive plug 6 and one end of the main housing 7 are cast integrally. The input conductive plug 6 and the main housing 7 form a whole during injection molding. One end of the input conductive plug 6 is located in the accommodating cavity 9, and the other end of the input conductive plug 6 is exposed outside the main housing 7. The input conductive plug 6 is used to connect the AC power supply, and the AC power is converted by the circuit on the circuit board 4 to be used by the LED lamp string.

The side wall of the main housing 7 is provided with a through hole 10. The light-emitting mode switching component 3 forms a sealing fit with the through hole 10 and is fixed with the main housing 7. In the present utility model, sealing means sealing the liquid, which prevents the liquid from entering the main housing 7. The preferred structure for matching the light-emitting mode switching component 3 with the through hole 10 is as follows.

The light-emitting mode switching component 3 comprises a sealing component and a signal trigger component 3h, the signal trigger component 3h is fixed with the sealing component, and the signal trigger component 3h is matched with the circuit board 4. In this embodiment, the signal trigger component 3h is a conductive component fixed with the sealing component, the circuit board 4 is provided with a signal trigger area, and the signal trigger component 3h is in clearance fit with the signal trigger area on the circuit board 4. The signal trigger component 3h is a conductive film, and the signal triggering area is also a conductive area. The conductive area can be a carbon film or other conductive parts. When the conductive film is in contact with the conductive area, a trigger signal for switching the light-emitting mode is generated.

The present utility model further comprises an annular protrusion 11. The through hole 10 consists of a first hole 10a, a second hole 10b and a step 10c connecting the first hole 10a and the second hole 10b. The inner diameter of the first hole 10a is larger than that of the second hole 10b. After the protrusion 11 is located in the first hole 10a and fixed with the step 10c, a first annular groove 12 is formed between the protrusion 11 and the hole wall of the first hole 10a. The light-emitting mode switching component 3 is matched with the first annular groove 12, the protrusion 11 and the second hole 10b, respectively.

After the light-emitting mode switching component 3 is mounted with the above structure, the output socket 5 is provided on the end cover 8, and the axial direction of the output socket 5 is parallel to the axial direction of the input conductive plug 6; or the included angle between the axial direction of the output socket 5 and the axial direction of the input conductive plug 6 is less than 3 degrees (as shown in FIG. 90. Preferably, the included angle between the axial direction of the output socket 5 and the axial direction of the input conductive plug 6 is 1.5 degrees. When in use, the converter plug is usually in an upright state. Therefore, if liquid enters the first annular groove 12, the liquid will flow to the outside of the first annular groove 12 under the action of gravity. In addition, the light-emitting mode switching component 3 forms a sealing fit with the first annular groove 12, the protrusion 11 and the second hole 10b, respectively, which prevents the liquid from entering the accommodating cavity 9. Therefore, according to the above two factors, the matching of the light-emitting mode switching component 3 and the through hole 10 has a good waterproof effect.

The light-emitting mode switching component 3 comprises a pressing component 3a, a sleeve 3b, an elastic connecting part 3g, and a signal trigger component 3h. The pressing component 3a passes through the sleeve 3b. One end of the sleeve 3b is provided with a waterproof cover 3c with an annular groove 3d. The annular groove 3d is matched with the protrusion 11. The waterproof cover 3c is matched with the first annular groove 12. The other end of the sleeve 3b is provided with a radial protrusion 3f The radial protrusion 3f forms a sealing fit with the second inner wall surface 7c of the main housing 7. Preferably, the radial protrusion 3f abuts against the second inner wall surface 7c. One end of the elastic connecting part 3g is connected with the pressing component 3a, and the other end of the elastic connecting part 3g is connected with the sleeve 3b. The signal trigger component 3h is fixed to the pressing component 3a.

The light-emitting mode switching component 3 is preferably made of silica gel material, so that the light-emitting mode switching component 3 has corresponding elastic deformation when stressed, so that the light-emitting mode switching component is assembled with the main housing 7 and forms a sealing structure. The pressing component 3a is a cylinder or cone. The outer diameter of the pressing component 3a is smaller than the inner diameter of the sleeve 3b. A space for the pressing component 3a to move is formed between the pressing component 3a and the sleeve 3b. For example, when the pressing component 3a moves axially, the pressing component 3a will not be hindered by the inner wall surface of the sleeve 3b.

In this embodiment, the second inner wall surface 7c and the protrusion 11 are clamped by the radial protrusion 3f and the waterproof cover 3c, so that the light-emitting mode switching component 3 and the main housing 7 are fixed. A first sealing structure is formed since the waterproof cover 3c is matched with the protrusion 11 and the first annular groove 12, and then a second sealing structure is formed since the radial protrusion 3f is matched with the second inner wall surface 7c.

The elastic connecting part 3g is tapered. The outer diameter of one end of the elastic connecting part 3g connected with the pressing component 3a is smaller than the diameter of the other end of the elastic connecting part 3g connected with the sleeve 3b. Therefore, when the user applies the axial force to the pressing component 3a, the elastic connecting part 3g deforms and accumulates elastic potential energy. After the pressing component 3a is released, the pressing component 3a is reset by the elastic connecting part 3g.

At least a part of the circuit board 4 is located in the accommodating cavity 9 and is electrically connected with the input conductive plug 6. One end of the light-emitting mode switching component 3 is matched with the signal trigger area on the circuit board 4, that is, the signal trigger component 3h is in clearance fit with the signal trigger area on the circuit board 4, wherein the signal trigger component 3h is a conductive film, and the signal trigger area is also a conductive area. When the signal trigger component is in contact with the signal trigger area, a trigger signal for switching the light-emitting mode is generated.

The circuit board 4 is provided with a control circuit. When an axial force is applied to the light-emitting mode switching component 3, the signal trigger component 3h at the end of the light-emitting mode switching component 3 is in contact with the signal trigger area, so that the control circuit can obtain an input signal for changing the light-emitting mode. An input signal is obtained in each contact. The processor in the control circuit outputs a control signal for changing the duty ratio according to a set program, thereby changing the light-emitting mode of the LED lamp string. The control circuit has been disclosed in various structures in the prior art, which will not be described in detail here.

The first inner wall surface 7b of the main housing 7 is provided with an assembly guide groove 7a, the circuit board 4 is inserted into the assembly guide groove 7a to be in clearance fit with the assembly guide groove 7a, and the first distance H1 between the assembly guide groove 7a and the second inner wall surface 7c of the main housing 7 is larger than the second distance H2 between one end of the light-emitting mode switching component 3 and the second inner wall surface 7c.

The function of making the first distance H1 larger than the second distance H2 is that in the case of not changing the height of the inner cavity of the existing main housing 7, on the one hand, if the first distance H1 is smaller than or equal to the second distance H2, when the circuit board 4 is inserted into the accommodating cavity 9 along the assembly guide groove 7a, the light-emitting mode switching component 3 will inevitably block the circuit board 4, so that the circuit board 4 is unable to be assembled with the main housing 7. If the circuit board is forcibly assembled, the light-emitting mode switching component 3 will be damaged.

On the other hand, since the electronic components on the circuit board 4 are usually fixed to the circuit board 4 by welding, the circuit board 4 and the electronic components will form a welding spot after welding. Since the welding spot is usually sharp, if the first distance H1 is smaller than or equal to the second distance H2, the sharp part of the welding spot will directly cut the light-emitting mode switching component 3 when the circuit board 4 is pushed forward.

Therefore, based on the above factors, it is necessary to leave a spacing distance between the circuit board 4 and the light-emitting mode switching component 3, so that the circuit board 4 can be mounted without damaging the light-emitting mode switching component 3. However, the fixing of the light-emitting mode switching component 3 will not rely on the abutting action of the circuit board 4 to obtain positioning, but on the structural changes of the light-emitting mode switching component 3 and the main housing 7 to fix them.

The circuit board 4 is provided with an input plug terminal 4a and an output plug terminal (not shown in the figure). After the circuit board 4 is inserted into the accommodating cavity 9 along the assembly guide groove 7a, the input plug terminal 4a automatically forms a plug fit with the input conductive plug 6. Similarly, after the end cover 8 is matched with the main housing 7, the output conductive plug (not shown in the figure) provided on the output socket 5 forms a plug fit with the output plug terminal. By the plug fit, on the one hand, the electric signal is transmitted. On the other hand, the mounting process of input and output is simplified.

However, the electrical fit between the input and output terminals mentioned above must be reliable, which means that the state of the circuit board 4 needs to be stable. If the circuit board 4 is displaced in the axial direction, the electrical fit between the input and output terminals may fail. Therefore, in order to avoid this problem, the end cover 8 is provided with a limiting part 8a, and after the end cover 8 is matched with the main housing 7, the limiting part 8a and the circuit board 4 form an abutment to limit the axial direction of the circuit board 4.

After the end cover 8 is fixed with the opening of the main housing 7, the end cover forms a sealed combination with the main housing 7. Preferably, the opening end of the main housing 7 is provided with an annular sleeving part 13, the end cover 8 is provided with a nesting part 14 which is mutually sleeved with the sleeving part 13 of the main housing 7, and the sleeving part 13 and the nesting part 14 are mutually matched, and then welded by ultrasonic waves.

In this embodiment, on the one hand, the end cover 8 and the main housing 7 use the structure that the sleeving part 13 and the nesting part 14 are matched with each other, and the end cover 8 and the main housing 7 are welded by ultrasonic waves; on the other hand, the area of the end cover 8 and the main housing 7 welded by ultrasonic waves is far less than the welding area of the upper cover and the lower cover in the prior art, so that the end cover and the main housing in this embodiment is waterproof and much more reliable than the upper cover and the lower cover combined in the prior art.

The sleeving part 13 comprises a first annular rib 13a and a second annular rib 13b, the first annular rib 13a surrounds the second annular rib 13b, and a second annular groove 13c is formed between the first annular rib 13a and the second annular rib 13b. The nesting part 14 comprises a third annular rib 14a and a fourth annular rib 14b, the third annular rib 14a surrounds the fourth annular rib 14b, and a third annular groove 14c is formed between the third annular rib 14a and the fourth annular rib 14b. The second annular rib 13b is inserted into the third annular groove 14c, and the fourth annular rib 14b is inserted into the second annular groove 13c.

Through the above matching relationship, two waterproof walls are formed between the end cover 8 and the main housing 7 by the second annular rib 13b and the fourth annular rib 14b. When combined with welding by ultrasonic waves, the waterproof reliability of the end cover 8 provided with the main housing 7 is improved.

The sleeving part 13 further comprises a first tapered rib 13d, the first tapered rib 13d is located in the second annular groove 13c, one end of the first tapered rib 13d is fixed to the groove bottom wall of the second annular groove 13c, and after the fourth annular rib 14b is inserted into the second annular groove 13c, the tapered end of the first tapered rib 13d forms an interference fit with the end face of the fourth annular rib 14b. The reliability of the second waterproof wall is further improved since the first tapered rib 13d is matched with the fourth annular rib 14b.

The nesting part 14 further comprises a second tapered rib 14d, the second tapered rib 14d is located in the third annular groove 14c, one end of the second tapered rib 14d is fixed to the groove bottom wall of the third annular groove 14c, and after the second annular rib 13b is inserted into the third annular groove 14c, the tapered end of the third tapered rib 14d forms an interference fit with the end face of the second annular rib 13b. The reliability of the first waterproof wall is further improved since the third tapered rib 14d is matched with the second annular rib 13b.

With the above structure, the present utility model further provides an LED lamp, which comprises the LED lamp string 15 and the LED power supply described above. The output socket 5 in the LED power supply is connected with the LED lamp string 15. When in use, the LED lamp string 15 is first connected with the output socket 5, and then the input conductive plug 6 in the LED power supply is connected with the AC power supply. When different light-emitting effects need to be displayed, the light-emitting mode of the LED lamp string is changed by the light-emitting mode switching component 3.

The present utility model is not limited to the above embodiments. For example, the following modes are different from the above embodiments in that:

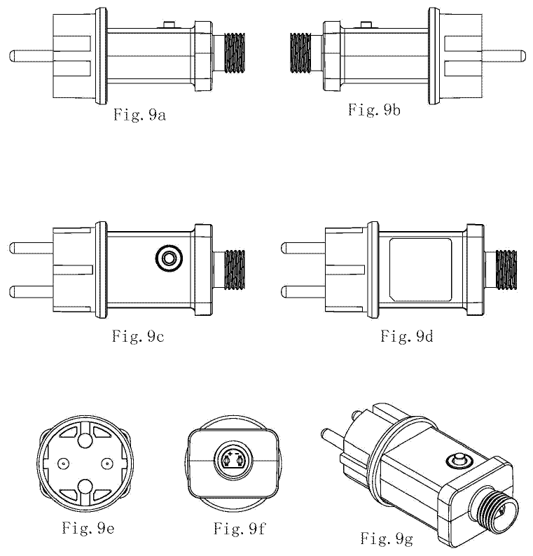

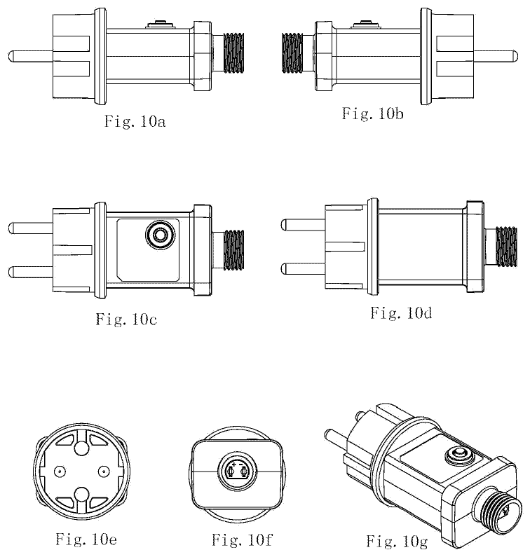

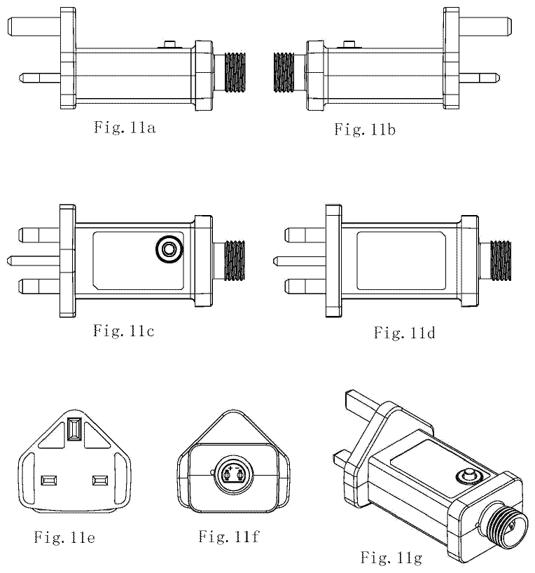

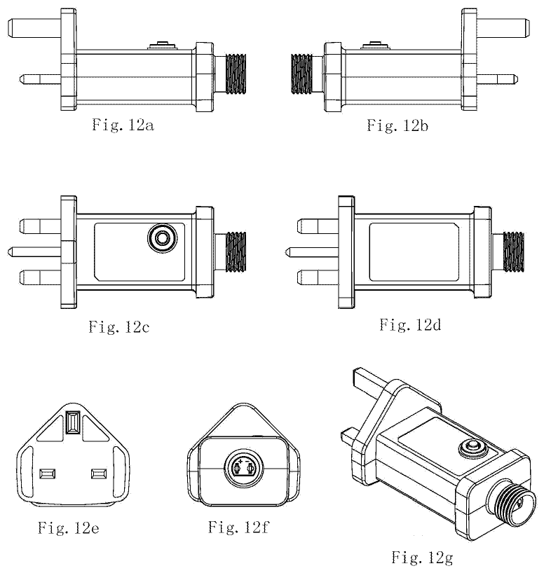

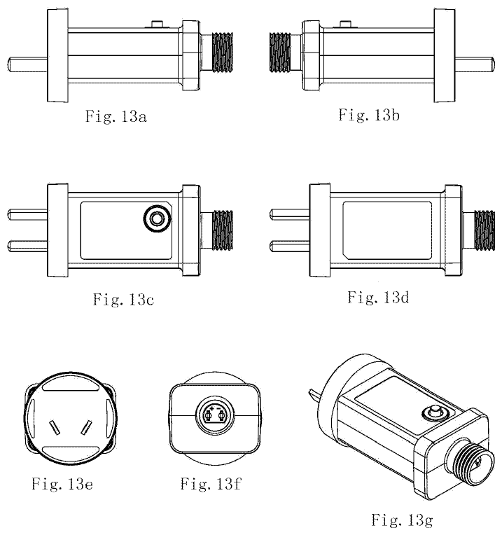

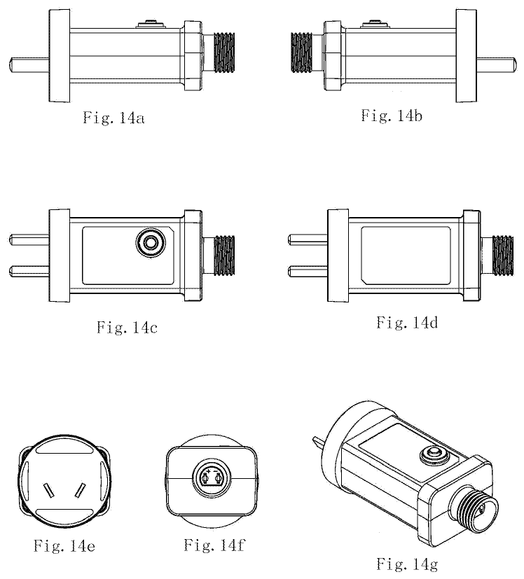

as shown in FIGS. 6b and 6c, the signal trigger component 3h is matched with the sealing component, and the signal trigger component 3h is fixed with the circuit board 4. Preferably, the signal trigger component 3h is a switch, one end of the switch is welded and fixed with the circuit board 4, and the other end of the switch is matched with the sealing component. The signal trigger component 3h preferably uses a touch switch. As for the sealing component, the length of the pressing component 3a is less than that of the sleeve 3b, so that the inner cavity of the sleeve 3b is partially empty, and the other end of the switch extends into the sleeve 3b to form a clearance fit with the sleeve 3b and the pressing component 3a.

In this way, since the signal trigger component 3h uses a switch, the switch needs to occupy a certain space, so that for the main housing 7, the height of the inner cavity of the main housing 7 will be increased compared with the main housing 7 in the prior art, and the switch will not interfere with the main housing 7 and the sealing component when the circuit board 4 is mounted in the main housing 7.

### CROSS REFERENCE

This application claims priority from Chinese Patent Application No CN 2021227116717, filed 2021 Aug. 11, the disclosure of which is incorporated herein in its entirety.

What is claimed is:

1. An LED power supply, comprising a housing, a light-emitting mode switching component (3), a circuit board (4), an output socket (5), and an input conductive plug (6), wherein the housing comprises a main housing (7) and an end cover (8), the main housing (7) is integrally formed, an accommodating cavity (9) is provided inside the main housing (7), one end of the main housing (7) is closed and the other end thereof is provided with an opening, the input conductive plug (6) and one end of the main housing (7) are cast integrally, one end of the input conductive plug (6) is located in the accommodating cavity (9), the side wall of the main housing (7) is provided with a through hole (10), a part of the light-emitting mode switching component (3) forms a sealing fit with the through hole (10) and is fixed with the main housing (7), at least a part of the circuit board (4) is located in the accommodating cavity (9) and is electrically connected with the input conductive plug (6), one end of the light-emitting mode switching component (3) is matched or fixed with the circuit board (4), after the end cover (8) is fixed with the opening of the main housing (7), the end cover forms a sealed combination with the main housing (7), the output socket (5) is provided on the end cover (8), the axial direction of the output socket (5) is parallel to the input conductive plug (6), or the included angle formed by the axial direction of the output socket (5) and the input conductive plug (6) is less than 3 degrees.

2. The LED power supply according to claim 1, wherein the light-emitting mode switching component (3) comprises a sealing component and a signal trigger component (3h), the signal trigger component (3h) is fixed or matched with the sealing component, and the signal trigger component (3h) is matched or fixed with the circuit board (4).

3. The LED power supply according to claim 2, wherein the signal trigger component (3h) is a conductive component fixed with the sealing component, the circuit board (4) is provided with a signal trigger area, and the signal trigger component (3h) is in clearance fit with the signal trigger area on the circuit board (4); or
the signal trigger component (3h) is a switch, one end of the switch is welded and fixed with the circuit board (4), and the other end of the switch is matched with the sealing component.

4. The LED power supply according to claim 2, wherein the sealing component comprises:
a pressing component (3a);
a sleeve (3b), wherein the pressing component (3a) is matched with the sleeve (3b), one end of the sleeve (3b) is provided with a waterproof cover (3c) with an annular groove (3d), the other end of the sleeve (3b) is provided with a radial protrusion (30, and the radial protrusion (30 forms a sealing fit with the second inner wall surface (7c) of the main housing (7);
an elastic connecting part (3g), wherein one end of the elastic connecting part (3g) is connected with the pressing component (3a), and the other end of the elastic connecting part (3g) is connected with the sleeve (3b).

6. The LED power supply according to claim 1, further comprising an annular protrusion (11), wherein the through hole (10) consists of a first hole (10a), a second hole (10b) and a step (10c) connecting the first hole (10a) and the second hole (10b), the inner diameter of the first hole (10a) is larger than that of the second hole (10b), after the protrusion (11) is located in the first hole (10a) and fixed with the step (10c), a first annular groove (12) is formed between the protrusion (11) and the hole wall of the first hole (10a), and the light-emitting mode switching component (3) is matched with the first annular groove (12), the protrusion (11) and the second hole (10b), respectively, to form a sealing structure.

7. The LED power supply according to claim 1, wherein the first inner wall surface (7b) of the main housing (7) is provided with an assembly guide groove (7a), the circuit board (4) is inserted into the assembly guide groove (7a) to be in clearance fit with the assembly guide groove (7a), and the first distance (H1) between the assembly guide groove (7a) and the second inner wall surface (7c) of the main housing (7) is larger than the second distance (H2) between one end of the light-emitting mode switching component (3) and the second inner wall surface (7c).

8. The LED power supply according to claim 1, wherein the end cover (8) is provided with a limiting part (8a), and after the end cover (8) is matched with the main housing (7), the limiting part (8a) and the circuit board (4) form an abutment to limit the axial direction of the circuit board (4).

9. The LED power supply according to claim 1, wherein the opening end of the main housing (7) is provided with an annular sleeving part (13), the end cover (8) is provided with a nesting part (14) which is mutually sleeved with the sleeving part (13) of the main housing (7), and the sleeving part (13) and the nesting part (14) are mutually matched, and then welded by ultrasonic waves.

10. The LED power supply according to claim 6, wherein the sleeving part (13) comprises a first annular rib (13a) and a second annular rib (13b), the first annular rib (13a) surrounds the second annular rib (13b), and a second annular groove (13c) is formed between the first annular rib (13a) and the second annular rib (13b);
the nesting part (14) comprises a third annular rib (14a) and a fourth annular rib (14b), the third annular rib (14a) surrounds the fourth annular rib (14b), and a third annular groove (14c) is formed between the third annular rib (14a) and the fourth annular rib (14b);
the second annular rib (13b) is inserted into the third annular groove (14c), and the fourth annular rib (14b) is inserted into the second annular groove (13c).

11. The LED power supply according to claim 7, wherein the sleeving part (13) further comprises a first tapered rib (13d), the first tapered rib (13d) is located in the second annular groove (13c), one end of the first tapered rib (13d) is fixed to the groove bottom wall of the second annular groove (13c), and after the fourth annular rib (14b) is inserted into the second annular groove (13c), the tapered end of the first tapered rib (13d) forms an interference fit with the end face of the fourth annular rib (14b).

12. The LED power supply according to claim 7, wherein the nesting part (14) further comprises a second tapered rib (14d), the second tapered rib (14d) is located in the third annular groove (14c), one end of the second tapered rib (14d) is fixed to the groove bottom wall of the third annular groove (14c), and after the second annular rib (13b) is inserted into the third annular groove (14c), the tapered end of the third tapered rib (14d) forms an interference fit with the end face of the second annular rib (13b).

13. An LED lamp comprising an LED lamp string (15), further comprising the LED power supply according to claim 1, wherein the output socket (5) in the LED power supply is connected with the LED lamp string (15).
